(19) United States
(12) Patent Application Publication
(10) Pub. No.: US 2024/0085283 A1
(43) Pub. Date: Mar. 14, 2024

(54) APPARATUS AND DEVICES FOR PROCESSING FLUID SAMPLES

(71) Applicant: Abbott Point of care Inc., Princeton, NJ (US)

(72) Inventor: Antti Virtanen, Princeton, NJ (US)

(21) Appl. No.: 18/516,026

(22) Filed: Nov. 21, 2023

Related U.S. Application Data
(63) Continuation of application No. PCT/US22/53129, filed on Dec. 16, 2022.
(60) Provisional application No. 63/309,031, filed on Feb. 11, 2022.
(60) Provisional application No. 63/333,841, filed on Apr. 22, 2022.
(60) Provisional application No. 63/402,115, filed on Aug. 30, 2022.
(60) Provisional application No. 63/423,118, filed on Nov. 7, 2022.

(51) Int. Cl. G01N 1/34; B01L 3/00

(52) U.S. Cl. CPC G01N 1/34; B01L 3/502753; B01L 2200/04; B01L 2200/0647; B01L 2300/0681; B01L 2300/165

(57) ABSTRACT

Disclosed herein is an apparatus for processing fluid samples such as blood or blood products. Also disclosed are devices comprising the apparatus as well as methods for separating plasma from blood or blood products using said apparatus.

### RELATED APPLICATION INFORMATION

This application is a continuation of International Application No. PCT/US22/53129, filed Dec. 16, 2022, which claims priority to U.S. Application No. 63/309,031, filed on Feb. 11, 2022, U.S. Application No. 63/333,841, filed on Apr. 22, 2022, U.S. Application No. 63/402,115, filed on Aug. 30, 2022, and U.S. Application No. 63/423,118, filed on Nov. 7, 2022, the contents of each of which are herein incorporated by reference.

### TECHNICAL FIELD

The present disclosure relates to an apparatus for processing fluid samples such as blood or blood products. In some aspects, the apparatus comprises a hydrophobic layer comprising at least one microchannel which defines a path for capillary fluid flow and a top layer flanking the hydrophobic layer, where the surface of the top layer facing the hydrophobic layer comprises a hydrophilic material. The present disclosure further relates to devices containing the apparatus and methods for separating plasma from blood or blood products using the apparatus.

### BACKGROUND

For many clinical diagnostic tests, plasma, rather than whole blood is the preferred sample for use in analysis. Traditionally, the separation of plasma has been accomplished through the centrifugation of a whole blood sample obtained from a subject. Centrifugation separates the blood into its various components, including serum and plasma, based on density and quantity. However, centrifugation is laborious, time consuming, requires additional instrumentation, and is inefficient for some applications, such as for core laboratory and point-of-care systems and use outside of a clinical setting (e.g., such as for use at home, in an office, etc.).

Point-of-care systems provide the medical industry with the ability to provide rapid and portable care for subjects in need thereof. Because of time restraints, the size of equipment, and operator use, centrifugation is impractical for use with these systems. Other separation methods, such as laminar-flow filtration or capillary-action based processes, are expensive, complex, time-consuming, require large volumes of blood, and may lead to unacceptable levels of hemolysis. Therefore, there is a need for new and improved devices and methods for separation of plasma from whole blood and blood products that are simple, require smaller sample sizes, and are cost effective, particularly for use in point-of-care systems.

### SUMMARY

In one embodiment, the present disclosure relates to an apparatus for fluid sample processing. The apparatus comprises:
a hydrophobic layer comprising at least one microchannel having a first and second channel which defines a path for capillary fluid flow; and
a top layer flanking the hydrophobic layer, wherein a surface of the top layer facing the hydrophobic layer is hydrophilic,
wherein the sample comprises blood or blood products.

In some aspects, the apparatus further comprises a bottom layer that flanks the hydrophobic layer, wherein a surface of the bottom layer facing the hydrophobic layer is hydrophilic.

In still other aspects, the top layer, hydrophobic layer, bottom layer, or any combination thereof are adherent to each other.

In still yet another aspect, the at least one microchannel extends longitudinally along a portion of the hydrophobic layer to an opening at a second end.

In still yet a further aspect, the at least one microchannel is less than about 80 mm in length.

In still yet another aspect, the at least one microchannel is less than about 5 mm wide.

In still yet another aspect, the top layer, bottom layer or top and bottom layers are entirely hydrophilic.

In still a further aspect, the composition of the entirety of the top layer, bottom layer, or both the top and bottom layers each comprise same or different materials.

In still further aspects, the hydrophobic layer, top layer, bottom layer or any combination thereof have a combined thickness of about 100 to about 600 microns.

In yet another aspect, the hydrophobic layer has thickness of about 100 to about 200 microns.

In still a further aspect, each of the top layer, bottom layer or top and bottom layers have a thickness of about 50 to about 200 microns.

In yet another aspect, the top layer of the apparatus comprises a sample inlet. In yet other aspects, when the top layer comprises a sample inlet, the hydrophobic layer and optionally, the bottom layer can each comprise an opening below the sample inlet. In still further aspects, the sample inlet comprises a separation membrane. In yet further aspects, the separation membrane is a plasma separation membrane. In yet other aspects, the apparatus further comprises a hydrophilic mesh or hydrophilic film positioned above the separation membrane, below the separation membrane, or both above and below the separation membrane. In yet further aspects, the opening in the hydrophobic layer is connected to a first end of the at least one microchannel.

In yet another aspect, the apparatus further comprises an agglutinating agent. In some aspects, the agglutinating agent comprises lectin (e.g., such as soybean lectin), Merquat-100, Concanavalin A, DEAE-Dextran, poly-L-lysine, polyvinylpyrrolidone, poly(2-(dimethylamino)ethylmethacrylate), or any combinations thereof. In yet further aspects, the agglutinating agent is coated on or incorporated into the separation membrane, the top layer, the hydrophobic layer, the bottom layer, or any combinations thereof.

In yet another embodiment, the present disclosure relates to a device. The device comprises:
1. the above-described apparatus; and
2. a sample analysis cartridge having a sample application area,
where the apparatus is configured with the sample analysis cartridge such that the at least one microchannel is in fluid communication with the sample application area.

In another aspect of the above device, an opening at a second end of the at least one microchannel is in fluid communication with the sample application area.

In still another embodiment, the present disclosure relates to a method for separating plasma from a blood or blood product sample. The method comprises the steps of:
collecting or receiving the blood or blood product sample;
contacting the blood or blood product sample with above-described apparatus; and
obtaining the plasma from an opening at the second end of the at least one microchannel.

In the above method, the blood or blood product sample has a volume of about 10 to about 500 uL. In some aspects in the above method, the blood or blood product sample has a volume of about 50 to about 500 uL. In yet other aspects of the above method, the blood or blood product sample has a volume of about 50 to about 400 uL. In yet other aspects of the above method, the blood or blood product sample has a volume of about 50 to about 300 uL. In yet other aspects of the above method, the blood or blood product sample has a volume of about 50 to about 200 uL. In some other aspects in the above method, the blood or blood product sample has a volume of about 10 to about 50 uL. In yet further aspects of the above method, the blood or blood product sample is applied to the sample inlet of the first layer. In yet further aspects of the above method, the plasma comprises less than 5% by volume red blood cells.

### BRIEF DESCRIPTION OF THE DRAWINGS

FIG. 1 shows one embodiment of an apparatus of the present disclosure.

FIG. 2 shows another embodiment of an apparatus of the present disclosure.

FIG. 3 shows a further embodiment of an apparatus of the present disclosure as described in Example 1.

FIG. 4 shows a device comprising an apparatus of the present disclosure that is operatively linked, removably coupled, or in fluid communication with a sample analysis cartridge. The second end of the microchannel of the apparatus is in fluid communication with a sample application area on the sample analysis cartridge.

FIG. 5 shows the CK-MB concentration results individually (left) and by mean with 95% confidence intervals (right) as described in Example 2. Each error bar was generated using a 95% confidence interval of the mean.

FIG. 6 shows the β-hCG concentration results from phase 3.2-3.3 individually (left) and by mean with 95% confidence intervals (right) as described in Example 3. Each error bar was generated using a 95% confidence interval of the mean.

FIG. 7 shows the GFAP plasma readings (pg/mL) for only venous and capillary plasma samples on the TBI Plasma Cartridge for donors taken in the study described in Example 4. Individual results (left) and mean results with 95% CI's (right) are included. Each error bar was generated using a 95% confidence interval of the mean.

FIG. 8 shows UCH-L1 plasma readings (pg/mL) for only venous and capillary plasma samples on the TBI Plasma Cartridge for donors taken in the study described in Example 4. Individual results (left) and mean results with 95% CI's (right) are included. Each error bar was generated using a 95% confidence interval of the mean.

### DETAILED DESCRIPTION

In one embodiment, the present disclosure relates to an apparatus for processing fluid samples such as blood samples or blood products. In some aspects, the apparatus comprises: (1) a hydrophobic layer comprising at least one microchannel having a first and a second end which defines a path for capillary fluid flow; and (2) a top layer that flanks or is positioned above the hydrophobic layer. In some aspects, the surface of the top layer facing the hydrophobic layer comprises a hydrophilic material. In other aspects, the apparatus can optionally further comprise a bottom layer that flanks or is positioned below the hydrophobic layer. When the bottom layer is present, the surface of the bottom layer facing the hydrophobic layer comprises a hydrophilic material. In yet further aspects, the top layer comprises a sample inlet. In still further aspects, the sample inlet comprises a separation membrane. In some aspects, the hydrophobic layer and optionally, the bottom layer, comprise an opening below the sample inlet. In yet further aspects, the opening in the hydrophobic layer is connected to the first end of the microchannel.

In another embodiment, the present disclosure relates to a device comprising the apparatus. In addition, the device can further comprise a sample analysis cartridge having a sample application area. The apparatus can be configured with the sample analysis cartridge such that at least one microchannel is operably linked, removably coupled, or in fluid communication with the sample application area.

In yet another embodiment, the present disclosure relates to a method for separating plasma from a blood or blood product sample. The method comprises collecting or receiving the blood or blood product sample, contacting the blood or blood product sample with the apparatus and obtaining the plasma from an opening at the second end of the at least one microchannel.

Section headings as used in this section and the entire disclosure herein are merely for organizational purposes and are not intended to be limiting.

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

“Blood” and “whole blood” as used interchangeably herein refers to the blood that flows through the veins of a subject and comprises red blood cells, white blood cells, and platelets suspended in a protective yellow liquid known as plasma.

“Blood product” as used herein refers to a substance derived from a subject's (e.g., a human) blood, and includes whole blood, blood components and plasma derivatives.

“Cartridge” as used herein refers to a hollow container and/or chip that comprises one or more substances and/or components (e.g., a liquid, reagents (e.g, antibodies and/or antigens), and/or a particle (e.g., a bead, or microparticle)) for insertion into an apparatus (e.g., a point-of-care device). In some aspects, a cartridge has one or more apertures. In some aspects, a cartridge is a microfluidic cartridge.

“Higher throughput assay analyzer” or a “non-point-of-care device”, as used interchangeably herein, refers to a device that is not a point-of-care device or a single use device. A higher throughput assay analyzer or non-point-of-care device refers to any device that does not meet any of the limitations of a point-of-care or a single use device as defined herein. In some embodiments, a “higher throughput assay analyzer” or “non-point-of-care device” refers to an instrument that: (a) may be a relatively large instrument compared to a hand-held point-of-care device, e.g., such as ranging in size from that of a tabletop instrument (e.g., typically considered low- or medium-throughput) to a large room-size or multiple-room-size instrument (e.g., typically considered high throughput); (b) is not a handheld instrument; (c) is capable of performing an assay on more than one clinical sample simultaneously; and (d) any combination of (a)-(c). A higher throughput assay analyzer may be a clinical chemistry analyzer, an immunoassay analyzer, or a combination thereof. Exemplary higher throughput assay analyzers or non-point-of-care devices include, for example, the ARCHITECT or Alinity platforms produced by Abbott Laboratories.

As used herein the term “hydrophilic”, such as in reference to a “hydrophilic material” (e.g., membrane, film, etc.) refers to those materials having a water contact angle of less than about 40 degrees.

As used herein the term “hydrophobic”, such as in reference to a “hydrophobic material” (e.g., membrane, film, etc.) refers to those materials having a water contact angle greater than about 80 degrees.

As used herein, the term “microchannel” refers to a channel having a cross-sectional dimension (namely, height and width) that is less than about 200 μm. In some aspects, the channel has a cross-sectional dimension of less than about 150 μm. In yet other aspects, the channel has a cross-sectional dimension of less than about 100 μm. In some aspects, the microchannel does not contain a filter at any point along its length. In yet other aspects, the microchannel contains one or more filters at any point along its length.

“Operatively coupled” or “operatively linked” as used herein means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true. Where movement is capable between a first element and another element, and vice versa, the elements are said to be “reciprocally operatively coupled”.

“Point-of-care device” refers to a device used to provide medical diagnostic testing at or near the point-of-care (namely, typically, outside of a laboratory), at the time and place of patient care (such as in a hospital, physician's office, urgent or other medical care facility, a patient's home, a nursing home and/or a long term care and/or hospice facility). Examples of point-of-care devices include those produced by Abbott Laboratories (Abbott Park, Ill.) (e.g., i-STAT and i-STAT Alinity, Universal Biosensors (Rowville, Australia) (see US 2006/0134713), Axis-Shield PoC AS (Oslo, Norway) and Clinical Lab Products (Los Angeles, USA).

“Removably coupled” or “removably linked” as used herein means that one component is coupled with another component in an essentially temporary manner. That is, the two components are coupled in such a way that the joining or separation of the components is easy and does not damage the components. Accordingly, “removably coupled” components may be readily uncoupled and recoupled without damage to the components.

“Subject” and “patient” as used herein interchangeably refers to any vertebrate, including, but not limited to, a mammal (e.g., cow, pig, camel, llama, horse, goat, rabbit, sheep, hamsters, guinea pig, cat, dog, rat, and mouse, a non-human primate (for example, a monkey, such as a cynomolgus or rhesus monkey, chimpanzee, etc.) and a human). In some embodiments, the subject may be a human or a non-human. In some embodiments, the subject is a human. The subject or patient may be undergoing other forms of treatment.

Unless otherwise defined herein, scientific and technical terms used in connection with the present disclosure shall have the meanings that are commonly understood by those of ordinary skill in the art. For example, any nomenclatures used in connection with, and techniques of, cell and tissue culture, molecular biology, immunology, microbiology, genetics and protein and nucleic acid chemistry and hybridization described herein are those that are well known and commonly used in the art. The meaning and scope of the terms should be clear; in the event, however of any latent ambiguity, definitions provided herein take precedent over any dictionary or extrinsic definition. Further, unless otherwise required by context, singular terms shall include pluralities and plural terms shall include the singular.

### 2. Apparatus for Fluid Sample Processing, Devices, and Methods for Separating Plasma from Blood Samples and Blood Products

In one embodiment, the present disclosure relates to an apparatus for fluid sample processing. The fluids that can be processed using the apparatus described herein include biological fluids or samples, such as blood samples and blood products. For example, in some aspects, a blood sample can be processed using the apparatus described herein into a plasma sample which can be used in a further diagnostic test, such as in a point-of-care assay or in an assay used in a higher throughput analyzer.

In one aspect, the apparatus comprises a hydrophobic layer comprising at least one microchannel and a top layer that flanks or is positioned above or on top of the hydrophobic layer. The hydrophobic layer can comprise or be constructed from at least one hydrophobic material. The hydrophobic material can be a membrane, film, fabric, fiber, filter, microfilm, screen, mesh, or any combination thereof. In one aspect, the hydrophobic layer is a membrane or film. Hydrophobic membranes or films that can be used are those known in the art. Specifically, membranes or films such as those available from Adhesive Research (Glen Rock, PA), 3M (Minneapolis, Minnesota), and/or Tesa SE (Norderstadt, Germany) can be used.

The hydrophobic layer comprises at least one microchannel having a first and second end which defines a path for capillary fluid flow of a processed blood sample or blood product (e.g., plasma). In some aspects, at least one microchannel extends longitudinally along a portion of the hydrophobic layer from the first end to an opening at the second (e.g., opposite) end of the microchannel. In other aspects, the at least one microchannel extends the width of a portion of the hydrophobic layer from the first end to an opening at the second (e.g., opposite) end of the microchannel. In some aspects, the microchannel contains a first opening connected to the first end of the microchannel. In these aspects, the processed blood or blood product (e.g., plasma) can flow from the first opening into the first end of the microchannel to the second opening at the second end of the microchannel.

The opening at the second end of the microchannel allows the processed blood or blood product (e.g., plasma) to flow out of the apparatus. For example, if the fluid being processed is blood, plasma can flow from the first end towards the second opening at the second (e.g., opposite) end by capillary fluid flow. The plasma can be collected at the second (e.g., opposite) end using a collection or other device or, if the apparatus is operably linked, removably coupled, or in fluid communication with another device (such as a sample analysis cartridge (such as a microfluidic cartridge)), allowed to continue to flow directly on or into the device for further processing and/or analysis.

The microchannel can be of any length. In some aspects, the microchannel is less than about 80 mm in length. In yet other aspects, the at least one microchannel is about 70 mm in length, the at least one microchannel is about 60 mm in length, about 55 mm in length, about 50 mm in length, about 45 mm in length, about 40 mm in length, about 35 mm in length, about 30 mm in length, about 25 mm in length, about 20 mm in length or about 15 mm in length. In yet other aspects, the at least one microchannel is less than about 5 mm wide, less than about 4.5 mm wide, less than about 4 mm wide, about 3 mm wide, less than about 2.5 mm wide, or less than about 2.0 mm wide.

Additionally, the at least one microchannel can be positioned at any location on the hydrophobic layer. For example, the at least one microchannel can be centered on the hydrophobic layer, it can be slightly off center on the hydrophobic layer, or it can be at or close to a side or edge of the hydrophobic layer. In yet other aspects, the microchannel does not contain a filter or any type of filtering device (e.g., the microchannel does not contain a filter or filtering device at any point between its first and second end which defines the path for capillary fluid flow of the processed blood sample or blood product).

In yet additional aspects, the hydrophobic layer can have a thickness of about 50 to about 200 microns. In yet other aspects, the hydrophobic layer can have a thickness of about 100 to about 200 microns. In some aspects, the hydrophobic layer can have a thickness of about 100 to about 150 microns.

The apparatus also comprises a top layer that flanks or is positioned above or on top of the hydrophobic layer. In some aspects, the top layer is adherent to the hydrophobic layer. In yet further aspects, the surface of the top layer that faces the hydrophobic layer comprises a material or is coated with a hydrophilic material. The hydrophilic material can be an adhesive, membrane, film, fabric, fiber, filter, microfilm, screen, mesh, or any combination thereof. In other aspects, the entire top layer is made or constructed of a hydrophilic material such as a membrane, film, fabric, fiber, filter, microfilm, screen, mesh, or any combination thereof. For example, in one aspect, the top layer is a membrane or film. In some aspects, the membrane or film is not constructed from a hydrophilic material but is coated with a hydrophilic material. The portion of the top layer coated with the hydrophilic material faces the hydrophobic layer. In another aspect, the entire membrane or film is made or constructed from a hydrophilic material. Hydrophilic membranes or films that can be used are those known in the art. An example of hydrophilic film that can be used is 9984 Diagnostic Microfluidic Surfactant Free Hydrophilic Film available from 3M (Minneapolis, MN), Kemafoil H, Hydrophilic coated polyester film from Coveme (S. Lazzaro diSavena, Italy), Tesa 62580, Hydrophilic coated polyester film from Tesa SE (Norderstadt, Germany). In yet additional aspects, the top layer can have a thickness of about 50 to about 200 microns. In yet other aspects, the top layer can have a thickness of about 100 to about 200 microns. In some aspects, the top layer can have a thickness of about 100 to about 150 microns.

When a blood sample or blood product is placed on the top layer of the apparatus, the blood sample or product flows through the top layer. As it does so, cellular components of the blood (e.g., red blood cells, white blood cells, platelets, and combinations thereof) are captured in the pores and/or fibers of the hydrophilic material thereby allowing the plasma to continue to flow through the hydrophilic material to the hydrophobic layer and into the microchannel. Once in the microchannel, the plasma flows by capillary fluid flow from the first end to the opening at the second (e.g., opposite) end of the channel. The plasma can be collected using a collection or other device, or, if the apparatus is operably linked, removably coupled, or in fluid communication with another device (such as a sample analysis cartridge (e.g., a microfluidic cartridge), allowed to continue to flow directly on or into the device for further processing and analysis.

In another aspect, the apparatus optionally comprises a bottom layer. The bottom layer is flanked or is positioned below or beneath the hydrophobic layer. In these aspects, the apparatus comprises at least three layers—a top layer, a hydrophobic layer and a bottom layer. In some aspects, the bottom layer is adherent to the hydrophobic layer. In additional aspects, the top layer and bottom layer are each adherent to the hydrophobic layer.

In yet further aspects, the surface of the bottom layer that faces the hydrophobic layer comprises a material or is coated with a hydrophilic material. The hydrophilic material can be an adhesive, membrane, film, fabric, fiber, filter, microfilm, screen, mesh, or any combination thereof. In other aspects, the entire bottom layer is made or constructed from a hydrophilic material such as a membrane, film, fabric, fiber, filter, microfilm, screen, mesh, or any combination thereof. For example, in one aspect, the bottom layer is a membrane or film. In some aspects, the membrane or film is not constructed from a hydrophilic material but is coated with a hydrophilic material. The portion of the bottom layer coated with the hydrophilic material faces the hydrophobic layer. In another aspect, the entire membrane or film is made or constructed from a hydrophilic material. Hydrophilic membranes or films that can be used are those known in the art. An example of hydrophilic film that can be used is 9984 Diagnostic Microfluidic Surfactant Free Hydrophilic Film available from 3M (Minneapolis, MN), Kemafoil H, Hydrophilic coated polyester film from Coveme (S. Lazzaro diSavena, Italy), Tesa 62580, Hydrophilic coated polyester film from Tesa SE (Norderstadt, Germany).

In yet additional aspects, the bottom layer can have a thickness of about 50 to about 200 microns. In yet other aspects, the bottom layer can have a thickness of about 100 to about 200 microns. In some aspects, the bottom layer can have a thickness of about 100 to about 150 microns.

In still further aspects, the apparatus can contain a protective film which flanks or is positioned below or beneath the bottom layer. In some aspects, the protective film is adherent to the bottom layer. The protective film protects the apparatus from moisture and/or other contamination. The protective film can be a plastic film, such as a self-adhesive plastic film, cardboard with adhesive, a plastic sheet with adhesive, or combinations thereof.

In yet other aspects, when the apparatus contains a top layer, a hydrophobic layer and a bottom layer, the combined thickness of the three layers is between about 100 to about 600 microns. In other aspects, the combined thickness of the three layers is between about 150 to about 600 microns. In other aspects, the combined thickness of the three layers is between about 200 to about 600 microns. In yet other aspects, the combined thickness of the three layers is between about 150 to about 500 microns. Still yet further aspects, the combined thickness of the three layers is between about 200 to about 500 microns.

Additionally, in some aspects, when the apparatus contains a top layer, a hydrophobic layer and a bottom layer, the top layer and the bottom layer can be made from the same material. Alternatively, the top layer and the bottom layer can be made from different materials. For example, the top layer and bottom layer can be made or constructed from the same hydrophilic material or different hydrophilic materials. Alternatively, the top and bottom layers may be made or constructed from a material that is not hydrophilic but are coated with a hydrophilic material on the surface of the layer that faces the hydrophobic layer. Still further, either one of the top or bottom layers may be made or constructed from a material that is not hydrophilic and coated with a hydrophilic material on the surface facing the hydrophobic layer and the other layer made entirely from a hydrophilic material.

In some aspects, the top layer comprises a sample inlet where the blood sample or blood product is placed to begin the sample processing through the apparatus. The sample inlet can have any shape. For example, the sample inlet can be round, oval, rectangular, square, triangular, or any combination thereof. In some aspects, a hydrophobic transfer material (e.g., such as a transfer tape) can surround the sample inlet. The hydrophobic transfer material helps prevent the blood sample or blood product from wicking or moving away from the sample inlet area.

When the top layer comprises a sample inlet, the hydrophobic layer and optionally, the bottom layer, comprise one or more openings. The openings can have any shape. For example, the opening can be round, oval, rectangular, square, triangular, or any combination thereof. The opening can have the same shape as the sample inlet or it can have a different shape. In some aspects, when the apparatus contains two layers (e.g., a top layer having a sample inlet and a hydrophobic layer), one or more openings can be made in the hydrophobic layer. In yet other aspects, when the apparatus contains three layers, one or more openings can be made in the hydrophobic layer but not in the bottom layer. In other aspects, when the apparatus contains three layers, one or more openings can be made in each of the hydrophobic layer and bottom layer. Each opening in the one or more layers can be directly below the sample inlet.

In some aspects, the apparatus described herein is used to separate plasma from whole blood in a horizontal orientation. In other aspects, the apparatus is used to separate plasma from whole blood in vertical orientation. When the apparatus is used vertically, when loading, the microchannel can be bent 90 degrees (e.g., keeping the membrane horizontal and channel vertical), or alternatively, a closed inlet with a funnel like structure can be used.

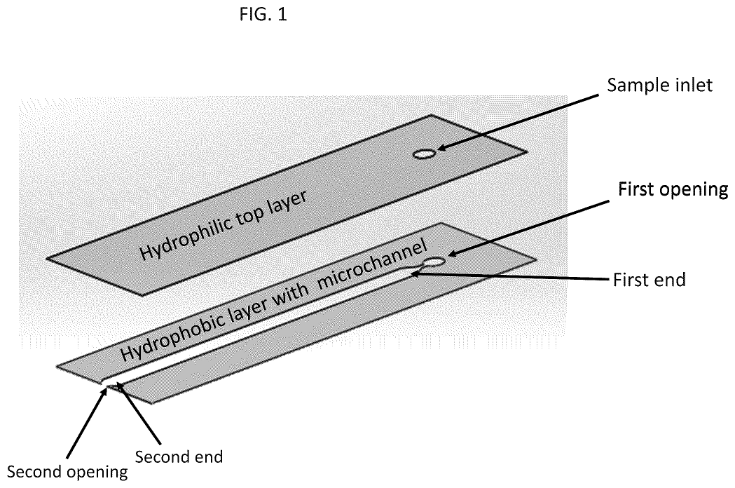

For example, FIG. 1 illustrates one embodiment of the apparatus of the present disclosure, which is being used in a horizontal orientation, which contains a hydrophilic top layer and a hydrophobic layer containing a microchannel having a first and second end. The top layer is adherent to the hydrophobic layer. The hydrophilic top layer comprises a sample inlet and the hydrophobic layer contains a first opening directly below the sample inlet. The first opening in the hydrophobic layer directly below the sample inlet is connected to the first end of the microchannel. When the plasma reaches the first opening on the hydrophobic layer, it flows from the opening into the first end of the microchannel and continues to flow to the second opening at the second end (e.g., opposite end) where it can be collected or allowed to flow directly on or into a sample analysis cartridge.

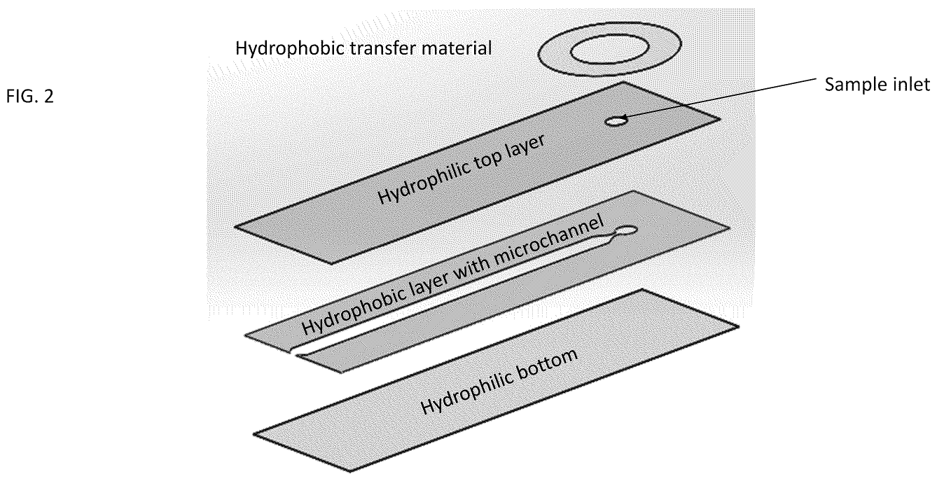

FIG. 2 illustrates another embodiment of the apparatus of the present disclosure, which is being used in a horizontal orientation. In this embodiment, the apparatus comprises a hydrophilic top layer, a hydrophobic layer and a hydrophilic bottom layer. The hydrophilic top layer is adherent to the hydrophobic layer and the bottom layer is adherent to the hydrophobic layer. The hydrophilic top layer comprises a hydrophobic transfer tape and a sample inlet. The hydrophobic layer contains a first opening directly below the sample inlet. The first opening in the hydrophobic layer directly below the sample inlet is connected to the first end of the microchannel. When the plasma reaches the first opening on the hydrophobic layer, it flows into the first end of the microchannel and continues to flow to the second opening at the second (e.g., opposite) end where it can be collected or allowed to flow directly on or into a sample analysis cartridge.

In still further aspects, the sample inlet can further comprise a separation membrane (such as a plasma separation membrane). In some aspects, the separation membrane is a glass fiber material, such as a membrane, film, fabric, fiber, filter, microfilm, screen, mesh, or any combination thereof. Additionally, the separation membrane can be in any shape. For example, the sample inlet can be round, oval, rectangular, square, triangular, or any combination thereof. In some aspects, the separation membrane can have the same shape as the sample inlet. In other aspects, the separation membrane can have a different shape than the sample inlet.

The separation membrane can be made from any material known in the art to be useful for separating blood samples or blood products into its components, such as plasma. When a blood sample or blood product is placed on a separation membrane, the blood sample or product flows through the membrane or material. As it flows through the membrane or material, cellular components of the blood (e.g., red blood cells, white blood cells, platelets, and combinations thereof) are captured in the pores and/or fibers of the membrane or material thereby allowing the plasma to continue to flow through the sample inlet and to the first opening on the hydrophobic layer. The first opening on the hydrophobic layer is connected to the microchannel such that when the plasma reaches the first opening on the hydrophobic layer, it flows into the first end of the microchannel and continues to flow to the second opening at the second (e.g., opposite end) of the microchannel. Once the plasma reaches the second opening at the second end of the microchannel, it can be collected using a collection or other device, or, if the apparatus is operably linked, removably coupled, or in fluid communication with another device (such as a sample analysis cartridge (e.g., a microfluidic cartridge), allowed to continue to flow directly on or into the device for further processing and analysis.

In some aspects, once the plasma reaches the first opening, second opening, or both the first and second opening of the microchannel, a pump, such as an air pump, foam ring pump, foil blister pump, film blister pump, or any combination thereof can be used to direct and/or disperse the plasma in the microchannel. In some aspects, the pump can be used to direct and/or disperse the plasma from the first end of the microchannel towards the second end of the microchannel. In yet other aspects, the pump can be used to direct and/or disperse the plasma from the second end of the microchannel towards and/or into another device (such as a sample analysis cartridge (e.g., a microfluidic cartridge). The pump can be connected at any point along the microfluidic channel, such as at the first opening, along the side, near the second end, or any combination thereof.

In some aspects, the separation membrane can be positioned or placed above, below or within the sample inlet. For example, in some aspects, the separation membrane can be cut to be larger than the size of the sample inlet and simply lay on top of the sample inlet. Alternatively, the separation membrane can be cut to be the same size or slightly smaller than the size of the sample inlet and be placed in the inlet. Still further, the separation membrane can be placed underneath the sample inlet and attached or adhered by any means known in the art, such as by an adhesive, glue, etc.

When the hydrophobic layer and/or bottom layer contain one or more openings, the hydrophobic layer and/or bottom layer can further contain one or more separation membranes positioned or placed above, below or within the opening in the layer. The separation membrane can be constructed from the same materials as used for the sample inlet or can be constructed from different materials. In still further aspects, the separation membrane can be positioned or placed above, below or within one or more openings. For example, in some aspects, the separation can be cut to be larger than the size of the opening and simply lay on top of the opening. Alternatively, the separation membrane can be cut to be the same size or slightly smaller than the size of the opening and be placed in the inlet. Still further, the separation membrane can be placed underneath the opening and attached or adhered by any means known in the art, such as by an adhesive, glue, etc.

In yet further aspects, one or more hydrophilic meshes or hydrophilic films can flank the separation membrane at the sample inlet and/or one or more openings. For example, a hydrophilic mesh or hydrophilic film can be positioned above or on top of the separation membrane to facilitate the spread of the blood sample or blood product into the apparatus. Alternatively, a hydrophilic mesh or hydrophilic film can be positioned below or beneath the separation membrane to help facilitate the continued movement of the blood sample or blood product as it is processed through to the hydrophobic layer and the first opening that is connected to the first end of the microchannel.

In some aspects, the apparatus further comprises an upper substrate material that comprises a sample inlet. The upper substrate material flanks or is positioned above or on top of the top layer. In some aspects, the top layer is adherent to the upper substrate. The upper substrate material can be a membrane, film, fabric, fiber, filter, microfilm, screen, mesh, or any combination thereof. In some aspects, the upper substrate material is made of a hydrophilic material. In other aspects, the upper substrate material is made from a hydrophobic material.

The upper substrate material comprises a sample inlet where the blood sample or blood product is placed to begin the sample processing. The sample inlet can have any shape. For example, the sample inlet can be round, oval, rectangular, square, triangular, or any combination thereof. In some aspects, a hydrophobic transfer material (e.g., such as a transfer tape) can surround the sample inlet. The hydrophobic transfer material helps prevent the blood sample or blood product from wicking or moving away from the sample inlet area.

In still further aspects, the sample inlet can comprise a separation membrane. In some aspects, the separation membrane comprises a glass fiber material such as a membrane, film, fabric, fiber, filter, microfilm, screen, mesh, or any combination thereof. The separation membrane can be made from any material known in the art to be useful for separating blood samples or blood products into its components, such as plasma. The separation membrane in the upper substrate functions in the same way as the separation membrane used in the sample inlet of the top layer.

In some aspects, the separation membrane can be positioned or placed above, below or within the sample inlet. For example, in some aspects, the separation membrane can be cut to be larger than the size of the sample inlet and simply lay on top of the sample inlet. Alternatively, the separation membrane can be cut to be the same size or slightly smaller than the size of the sample inlet and be placed in the inlet. Still further, the separation membrane can be placed underneath the sample inlet and attached or adhered by any means known in the art, such as by an adhesive, glue, etc.

When an upper substrate and sample inlet are present, one or more openings are made in each of the top layer and hydrophobic layer or each of the top layer, hydrophobic layer and optionally, the bottom layer. The opening can have any shape. For example, the opening can be round, oval, rectangular, square, triangular, or any combination thereof. In some aspects, the opening is the same shape as the sample inlet. In other aspects, the opening is a different shape as the sample inlet. In some aspects, when the apparatus contains an upper substrate, one or more openings can be made in the top layer and hydrophobic layer but not in the bottom layer. In other aspects, one or more openings can be made in each of the top layer, hydrophobic layer and bottom layer. Each opening in the one or more layers can be directly below the sample inlet. One or more openings in each of the top layer, hydrophobic layer and/or bottom layer can also contain one or more separation membranes positioned or placed above, below or within the opening in the layer. The separation membrane can be constructed from the same materials as used for the sample inlet or can be constructed from different materials. Additionally, one or more hydrophilic meshes or films can flank the separation membrane at the sample inlet and/or one or more openings. For example, a hydrophilic mesh or hydrophilic film can be positioned above or below the separation membrane as described previously herein.

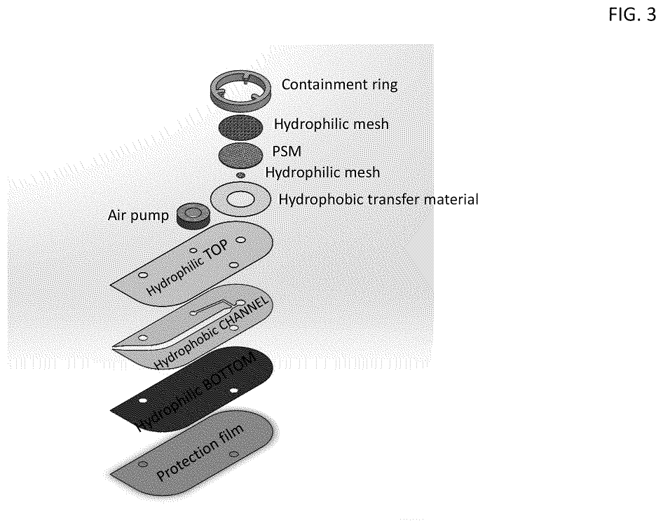

In yet still another aspect, FIG. 3 illustrates another embodiment of the apparatus of the present disclosure. The apparatus comprises a hydrophilic top layer, a hydrophobic layer with a microchannel having a first and second end, a hydrophilic bottom layer and a protective film. In some aspects, the apparatus does not contain a protective film. The hydrophilic top layer is adherent to the hydrophobic layer and the protective (or protection) film is adherent to the bottom hydrophilic layer which is adherent to the hydrophobic layer. The hydrophilic top layer, hydrophobic layer and bottom hydrophilic layer can be made from materials known in the art such as those discussed previously herein as well as those available from Tesa (Norderstedt, Germany). In addition, the top layer comprises a sample inlet.

The sample inlet is surrounded by a circular hydrophobic transfer tape which functions as a plasma collection zone. On top of the hydrophobic transfer tape is a plasma separation membrane (PSM) which is flanked on both its top and bottom surfaces with a hydrophilic mesh. The PSM can be made from any suitable materials such as discussed previously herein (e.g., such as Cytosep™ (Pall Corporation, Port Washington, NY) or materials available from Ahlstrom-Munksjo (Helsinki, Finland)) and is used to retain red blood cells in the PSM and generate plasma (or a “plasma front”) that proceeds through the PSM towards the sample inlet. The hydrophilic meshes can be made from any suitable material, such as those discussed previously herein (e.g., such as those available from Sefar Inc. (Buffalo, NY)). The hydrophilic meshes can be constructed from the same hydrophilic materials or different hydrophilic materials. The hydrophilic meshes can be the same size or different sizes.

The hydrophilic mesh positioned above or on top of the PSM assists in spreading the sample (e.g., whole blood). The hydrophilic mesh positioned beneath or below the PSM assists in facilitating the processing of the sample (e.g., whole blood sample) to the hydrophobic layer. In other words, it provides capillary contact between the plasma collection zone at the circular hydrophobic transfer tape and the microchannel. A containment ring, to assist in containing the sample (e.g., whole blood sample) encompasses the PSM, the hydrophilic meshes and the transfer tape. In addition to containing the sample, the containment ring holds the hydrophilic spreading layer mesh in place and in capillary contact with the PSM. In some aspects, the containment ring can be 3D printed or molded using routine techniques known in the art.

The hydrophobic layer contains an opening (e.g., first opening) directly underneath the sample inlet. The opening on the hydrophobic layer is connected to a first end of the microchannel. Plasma flows from the opening (e.g., first opening) at the first end towards the second opening at the second (e.g., opposite) end. The apparatus also contains an air pump for dispensing the separated plasma from the microchannel.

As illustrated in FIG. 3, the apparatus described herein is constructed by stacking various layers and optionally, films on top of one another other. The apparatus is not constructed by perforating or puncturing a substrate (such as an intermediate substrate) or layer and then then including one or more filters or layers in the perforation or puncture to filter the whole blood sample or whole blood product. Alternatively, in other aspects not shown in FIG. 3, the apparatus described herein can be constructed by perforating or puncturing a substrate or layer and including one or more filters or layers in the perforation or puncture to file the whole blood.

In yet still aspect, the top layer, hydrophobic layer, bottom layer, hydrophilic mesh or hydrophilic film, separation membrane, or any combination thereof is either ubiquitous for any analyte or specific for an analyte or class of analytes.

It was found that the volume of plasma that is generated by the apparatus depends on the hematocrit (% PCV) of the whole blood sample). Specifically, due to the short vertical separation distance in the apparatus, at higher hematocrits, the volume of the generated plasma can be lower than the volume of the microchannel. Plasma flows into the microchannel by capillary action but if the volume of plasma is not enough to fill the entire channel, then red blood cells held back by the separation membrane fill the remainder. Thus, as a result, in some aspects, the whole blood sample used with the apparatus has a hematocrit of less than about 40, less than about 39, less than about 38, less than about 37, less than about 36, less than about 35, less than about 34, less than about 33, less than about 32, less than about 31, less than about 30, less than about 29, less than about 28, less than about 27, less than about 26, less than about 25, less than about 24, less than about 23, less than about 22, less than about 21, less than about 20, less than about 19, less than about 18, less than about 17, less than about 16, or less than about 15. In some aspects, the whole blood sample used with the apparatus has a hematocrit of between about 15 to about 40. In other aspects, the whole blood sample used with apparatus has a hematocrit of between about 20 to about 35. In still other aspects, the whole blood sample used with the apparatus has a hematocrit of between about 25 to about 35.

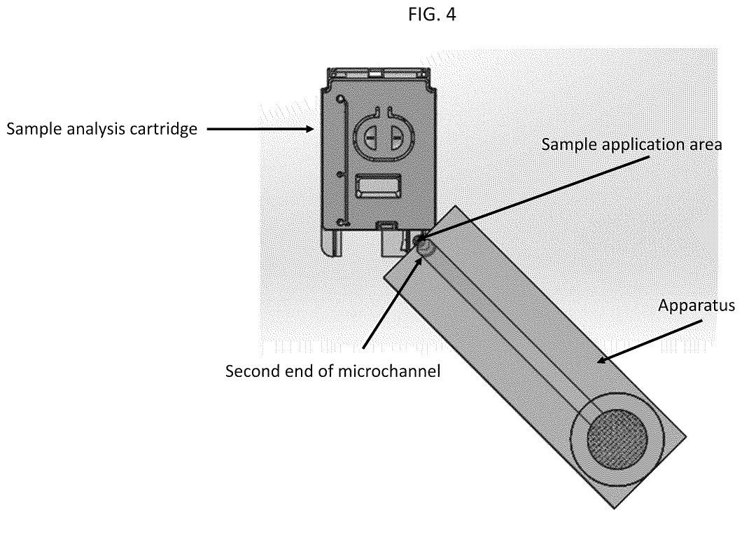

In still another aspect, the apparatus described herein, such as, for example, the apparatus shown in FIGS. 1-3, can be used in connection with a point-of-care device, such as shown, for example, in FIG. 4. The apparatus can also be optimized for use with a non-point-of-care device, such as a high throughput analyzer (e.g., a non-point-of-care device), using routine techniques known in the art. Such optimization could include increasing one or more of the length, width and/or thickness of the apparatus. For example, in some aspects, the apparatus can have a thickness of about 600 microns to about 10,000 microns. Additionally, in other aspects, the length and/or width of the microchannel can be increased. For example, the length of the microchannel can be from about 80 mm to about 200 mm in length and/or the width of the microchannel can be from about 5 mm to about 15 mm. In some aspects, the apparatus comprises one (e.g., a single microchannel). In other aspects, the apparatus can contain more than one microchannel. For example, the apparatus can contain at least 2 microchannels, at least 3 microchannels, at least 4 microchannels, or at least 5 microchannels.

The apparatus described herein, such as, for example, the apparatus shown in FIGS. 1-3, is a passive membrane-based separator. As described herein, whole blood can be applied on top of the membrane. A hydrophilic fabric enables a more even wetting on the top of the membrane and directs the blood to travel through the separation media vertically. Cell components are retained in the membrane matrix which generates an advancing plasma front. An uniform, almost column like travel of blood through the separation media maximizes the volume of plasma generated at the bottom of the membrane. Once the separation membrane is saturated, the plasma from the bottom of the membrane is directed into a microchannel by capillary action.

In still another aspect, the apparatus further comprises at least one agglutinating agent to agglutinate the red blood cells to form red blood cell aggregates to improve separation and produce a cleaner plasma. In some aspects, the agglutinating agent is coated or incorporated into or on one or more of the top layer, hydrophobic layer, bottom layer, upper substrate, separation membrane, hydrophilic mesh or hydrophilic film, or any combination thereof. Examples of an agglutinating agent that can be used includes, lectin (e.g., soybean lectin), Merquat-100, Concanavalin A, DEAE-Dextran, poly-L-lysine, polyvinylpyrrolidone, poly(2-(dimethylamino)ethylmethacrylate), or any combinations thereof.

In addition, the apparatus can further comprise one or more salts which can be used to achieve least a partial crenation of the red blood cells in the whole blood sample. Salts are ionic compounds that dissociate in water. Salts that can be used in the apparatus include both organic and inorganic salts. Examples of salts that can be used include, for example, calcium chloride, potassium chloride, sodium chloride, manganese chloride, magnesium chloride, potassium sulfate, guanidine hydrochloride and combinations thereof. In still yet another aspect, the top layer, hydrophobic layer, bottom layer, upper substrate, separation membrane, hydrophilic mesh or hydrophilic film, or any combination thereof, is coated with a coating, such as with a surfactant, hydrophilic coating or any combination thereof, to improve or increase the speed or rate of separation of the plasma and/or serum from whole blood as it passes through any of the layers, substrates, membranes, meshes, files, or any combination thereof.

The plasma produced using the apparatus disclosed herein may not be pure plasma but rather plasma depleted of one or more components of blood (e.g., red blood cells, white blood cells, platelets, and combinations thereof). In some aspects, the plasma contains about 5% by volume or less of red blood cells, white blood cells and/or platelets. In other aspects, the plasma contains about 5% or less by volume of red blood cells. In other aspects, the plasma contains about 4% or less by volume of red blood cells. In yet other aspects, the plasma contains about 3% or less by volume of red blood cells. In yet other aspects, the plasma contains about 2% or less by volume of red blood cells. In still yet further aspects, the plasma contains about 1% or less by volume of red blood cells. In other words, in some aspects, the product produced by the apparatus described herein is a product that is reduced in the number of blood cells (e.g., the product is red blood cell reduced) when compared to a whole blood sample or blood product that has not been contacted with the apparatus described herein.

In another embodiment, the present disclosure relates to a device. In one aspect the device comprises the apparatus described previously herein and at least one sample analysis cartridge (e.g., a microfluidic cartridge) having a sample application area where a test sample is applied. In one aspect, the apparatus is configured with the sample analysis cartridge such that the microchannel is operably linked, removably coupled, or in fluid communication with the sample application area. Specifically, as shown in FIG. 4, the second end of the microchannel can be in operably linked, removably coupled, or in fluid communication with a sample analysis cartridge at a sample application area. In another aspect, the apparatus is included or incorporated as part of a clip, such as a moby clip, extended moby clip, etc., and configured, coupled, or integrated with the sample analysis cartridge such that the microchannel is operably linked, removably coupled, or in fluid communication with the sample application area.

In still yet another embodiment, the present disclosure relates to a method for separating plasma from a blood sample or blood product. In some aspects, the method involves collecting or receiving a blood sample or blood product from a subject. In some aspects, the volume of blood sample or blood product used in the method is from about 10 to about 500 In some aspects, the volume of blood sample or blood product used in the method is from about 50 to about 500 uL. In still some other aspects, the volume of blood sample or blood product used in the method is from about 50 to about 400 uL. In still some other aspects, the volume of blood sample or blood product used in the method is from about 50 to about 300 uL. In still some other aspects, the volume of blood sample or blood product used in the method is from about 50 to about 200 uL. In still yet other aspects, the volume of blood sample or blood product is from about 10 to about 100 uL. In still yet other aspects, the volume of the blood sample or product is from about 10 to about 50 uL. In still yet other aspects, the volume of the blood sample or product is from about 10 to about 25 uL.

After collecting or receiving the sample or product, the blood is contacted and/or processed using the above-described apparatus. Plasma is obtained from the apparatus from the opening (second opening) at the second end of the at least one microchannel. The amount of plasma that can be extracted from the apparatus is about 10 to about 30 μL.

This application also incorporates by reference the disclosure in PCT/US2022/XXXXXX each titled “SYSTEMS AND METHODS FOR DETERMINING UCH-L1, GFAP, AND OTHER BIOMARKERS IN BLOOD SAMPLES” filed on Dec. 16, 2022 in its entirety.

The present disclosure has multiple aspects, illustrated by the following non-limiting examples.

### EXAMPLES

### Example 1

FIG. 3 shows an embodiment of an apparatus of the present disclosure. The apparatus comprises a hydrophilic top layer, a hydrophobic layer with a microchannel having a first and second end, a hydrophilic bottom layer and a protection film. The hydrophilic top layer is adherent to the hydrophobic layer and the protection film is adherent to the bottom hydrophilic layer which is adherent to the hydrophobic layer. The top layer comprises a sample inlet. The sample inlet is surrounded by a circular hydrophobic transfer tape. On top of the hydrophobic transfer tape is a plasma separation membrane (PSM) which is flanked on both its top and bottom surfaces with a hydrophilic mesh. The hydrophilic mesh positioned above or on top of the PSM assists in spreading the sample. The hydrophilic mesh positioned beneath or below the PSM assists facilitating the processing of the blood sample or blood product to the hydrophobic layer. A containment ring, to assist in containing the sample encompasses the PSM, the hydrophilic meshes and the transfer tape. The hydrophobic layer contains an opening (e.g., first opening) directly underneath the sample inlet. The opening on the hydrophobic layer is connected to a first end of the microchannel. Plasma flows from the opening (e.g., first opening) at the first towards the second opening at the second (e.g., opposite) end. The apparatus also contains an air pump for circulating air through the device.

### Example 2

This study was designed to compare the levels of CK-MB in capillary and venous blood samples obtained from normal subjects. Six (6) subjects were enrolled in this study. Each subject experienced two (2) blood draws. The first draw was a venous blood draw performed by a phlebotomist using routine venous blood collection techniques known in the art. The second blood draw was a capillary blood draw and was performed using the TAP II sample collection device which is commercially available from YourBio Health (Medford, MA), pursuant to the manufacturer's instructions. The TAP II sample collection device is described in WO 2020/223710, the contents of which are herein incorporated by reference.

The venous and capillary samples obtained from three (3) of the subjects were used to obtain plasma using the plasma separation device in FIG. 3. For three (3) subjects, venous and capillary whole blood was tested. For the remaining three (3) subjects, venous and capillary plasma was tested.

The venous whole blood and plasma samples and the capillary whole blood and plasma samples for each of the subjects were tested on the commercially available Abbott Laboratories iSTAT® CK-MB test (Abbott Laboratories, Abbott Park, Ill.). The test was run using investigational/engineering software to allow the test to run on the i-STAT Alinity Instrument.

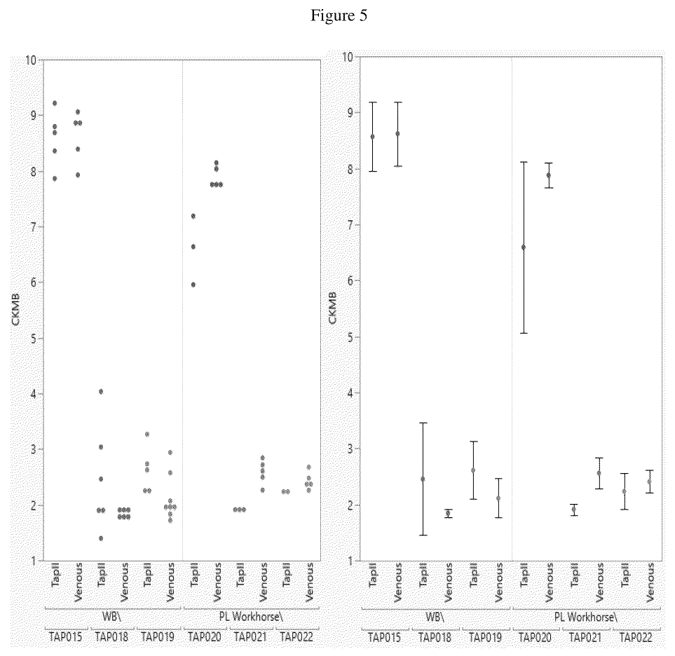

As shown in FIG. 5, the levels of CK-MB in the venous whole blood and plasma samples read similarly to the levels of CK-MB in the capillary whole blood and plasma samples.

### Example 3

This study was designed to compare the levels of total β-hCG in capillary and venous blood samples obtained from normal subjects. Six (6) subjects were enrolled in this study. Each subject experienced two (2) blood draws. The first draw was a venous blood draw performed by a phlebotomist using routine venous blood collection techniques known in the art. The second blood draw was a capillary blood draw and was performed using the TAP II sample collection device which is commercially available from YourBio Health (Medford, MA), pursuant to the manufacturer's instructions.

The venous and capillary samples obtained from three (3) of the subjects were used to obtain plasma using the plasma separation device in FIG. 3. For three (3) subjects, venous and capillary whole blood was tested. For the remaining three (3) subjects, venous and capillary plasma was tested.

The venous whole blood and plasma samples and the capillary whole blood and plasma samples for each of the subjects were tested on the commercially available Abbott Laboratories iSTAT® Total β-hCG test (Abbott Laboratories, Abbott Park, Ill.). The test was run using investigational/engineering software to allow the test to run on the i-STAT Alinity Instrument.

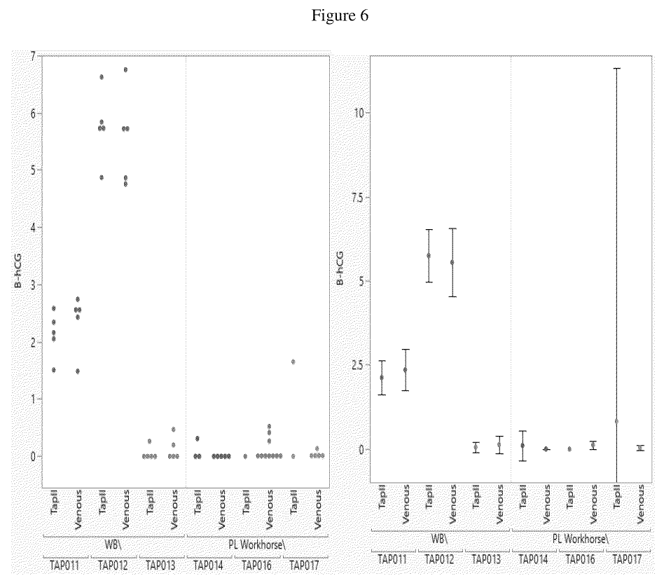

As shown in FIG. 6, the levels of β-hCG in the venous whole blood and plasma samples read similar to the levels of β-hCG in the capillary whole blood and plasma samples.

### Example 4

This study was designed to compare the levels of GFAP and UCH-L1 in capillary and venous plasma samples obtained from normal subjects. Plasma samples were collected from ten (10) subjects. Each subject experienced two (2) blood draws. The first draw was a venous blood draw performed by a phlebotomist using routine venous blood collection techniques known in the art. The second blood draw was a capillary blood draw and was performed using the TAP II sample collection device which is commercially available from YourBio Health (Medford, MA), pursuant to the manufacturer's instructions.

The venous and capillary blood samples obtained from every subject were used to obtain plasma using the plasma separation device in FIG. 3. For each subject, venous plasma samples and capillary plasma samples were tested.

The venous plasma samples and the capillary plasma samples for each of the ten (10) subjects were tested on the commercially available Abbott Laboratories iStat® TBI Plasma test (Abbott Laboratories, Abbott Park, Ill.).

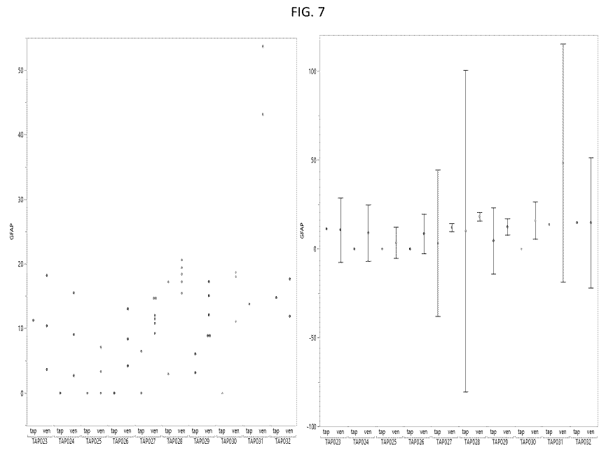

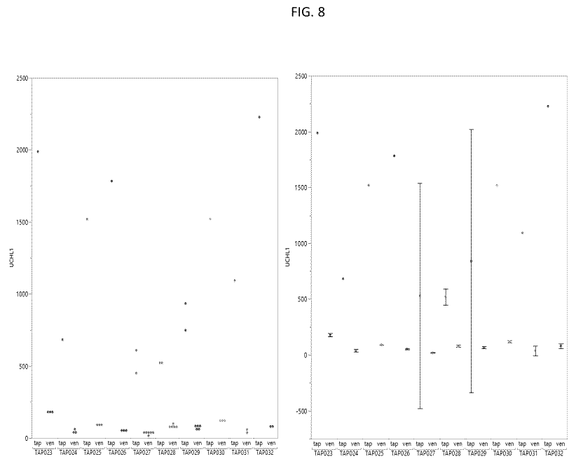

As shown in FIG. 7, the levels of GFAP in the venous plasma samples read similar to the levels of GFAP in the capillary plasma samples. As shown in FIG. 8, the levels of UCH-L1 in the capillary plasma samples were elevated compared to the venous plasma samples.

### Example 5

This study was designed to determine the concentration of cardiac troponin I (cTnI) in spiked plasma samples recovered using the plasma separation device shown in FIG. 3. Specifically, 2 different tests were performed. In both tests, plasma samples spiked with cTnI were placed on the apparatus shown in FIG. 3 and the resulting plasma cTnI concentration was measured and compared to a control sample that was not placed on the plasma separation device. The average cTnI concentration and the % of cTnI recovered in the samples is shown in Tables A and B below.

TABLE A

| | | Average cTnI | | | |
|---|---|---|---|---|---|
| | | concentration | | % | % cTnI |
| Condition | Count | (pg/mL) | SD | CV | recovery |
| Control | 4 | 58.6 | 1.4 | 2.4% | |
| Spiked samples | 4 | 62.3 | 1.7 | 2.8% | 106.1% |

TABLE B

| | | Average cTnI | | | |
|---|---|---|---|---|---|
| | | concentration | | % | % cTnI |
| Condition | Count | (pg/mL) | SD | CV | recovery |
| Control | 2 | 83.1 | 6.6 | 8.0% | |
| Spiked samples | 3 | 87.0 | 1.3 | 1.5% | 104.7% |

It will be readily apparent to those skilled in the art that other suitable modifications and adaptations of the methods of the present disclosure described herein are readily applicable and appreciable, and may be made using suitable equivalents without departing from the scope of the present disclosure or the aspects and embodiments disclosed herein. Having now described the present disclosure in detail, the same will be more clearly understood by reference to the following examples, which are merely intended only to illustrate some aspects and embodiments of the disclosure, and should not be viewed as limiting to the scope of the disclosure. The disclosures of all journal references, U.S. patents, and publications referred to herein are hereby incorporated by reference in their entireties.

The present disclosure has multiple aspects, illustrated by the non-limiting examples described herein.

It is understood that the foregoing detailed description and accompanying examples are merely illustrative and are not to be taken as limitations upon the scope of the disclosure, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the disclosure, may be made without departing from the spirit and scope thereof.

For reasons of completeness, various aspects of the disclosure are set out in the following numbered clauses:

Clause 1. An apparatus for fluid sample processing comprising:
a hydrophobic layer comprising at least one microchannel having a first and a second end which defines a path for capillary fluid flow; and
a top layer flanking the hydrophobic layer, wherein a surface of the top layer facing the hydrophobic layer is hydrophilic,
wherein the sample comprises blood or blood products.

Clause 2. The apparatus of clause 1, further comprising a bottom layer flanking the hydrophobic layer, wherein a surface of the bottom layer facing the hydrophobic layer is hydrophilic.

Clause 3. The apparatus of clause 1 or clause 2, wherein the top layer, hydrophobic layer, bottom layer, or any combination thereof are adherent to each other.

Clause 4. The apparatus of any of clauses 1-3, wherein the at least one microchannel extends longitudinally along a portion of the hydrophobic layer to an opening at a second end.

Clause 5. The apparatus of any of clauses 1-4, wherein the at least one microchannel is less than about 80 mm in length.

Clause 6. The apparatus of any of clauses 1-5 wherein the at least one microchannel is less than about 5 mm wide.

Clause 7. The apparatus of any of clauses 1-6, wherein the top layer, bottom layer or top and bottom layers are entirely hydrophilic.

Clause 8. The apparatus of any of clauses 1-7, wherein a composition of the entirety of the top layer, bottom layer, or both the top and bottom layers each comprise same or different materials.

Clause 9. The apparatus of any of clauses 1-8, wherein the hydrophobic layer, top layer, bottom layer or any combination thereof have a combined thickness of about 100 to about 600 microns.

Clause 10. The apparatus of any of clauses 1-9, wherein the hydrophobic layer has thickness of about 50 to about 200 microns.

Clause 11. The apparatus of any of clauses 1-10, wherein each of the top layer, bottom layer or top and bottom layers have a thickness of about 50 to about 200 microns.

Clause 12. The apparatus of any of clauses 1-11, wherein the top layer comprises a sample inlet.

Clause 13. The apparatus of clause 12, wherein the hydrophobic layer and optionally, the bottom layer, comprise an opening below the sample inlet.

Clause 14. The apparatus of clause 12 or clause 13, wherein the sample inlet comprises a separation membrane.

Clause 15. The apparatus of clause 14, wherein the separation membrane is a plasma separation membrane.

Clause 16. The apparatus of clause 14 or clause 15, further comprising a hydrophilic mesh or hydrophilic film positioned above the separation membrane, below the separation membrane, or both above and below the separation membrane.

Clause 17. The apparatus of any of clauses 13-16, wherein the opening in the hydrophobic layer is connected to the first end of the at least one microchannel.

Clause 18. The apparatus of any of clauses 1-17, further comprising an agglutinating agent.

Clause 19. The apparatus of clause 18, wherein the agglutinating agent comprises lectin, Merquat-100, Concanavalin A, DEAE-Dextran, poly-L-lysine, polyvinylpyrrolidone, poly(2-(dimethylamino)ethylmethacrylate), or any combinations thereof.

Clause 20. The apparatus of claim 18 or claim 19, wherein the agglutinating agent is coated or incorporated into the separation membrane, the top layer, the hydrophobic layer, the bottom layer, or any combination thereof.

Clause 21. A device comprising:
the apparatus of any one of clauses 1-20; and
a sample analysis cartridge having a sample application area,
wherein the apparatus is configured within the sample analysis cartridge such that the at least one microchannel is in fluid communication with the sample application area.

Clause 22. The device of clause 21, wherein an opening at the second end of the at least one microchannel is in fluid communication with the sample application area.

Clause 23. A method for separating plasma from a blood or blood product sample, the method comprising:
collecting or receiving the blood or blood product sample;
contacting the blood or blood product sample with the apparatus of any one of clauses 1-20; and
obtaining the plasma from an opening at the second end of the at least one microchannel.

Clause 24. The method of clause 23, wherein the blood or blood product sample has a volume of about 10 to about 500 uL.

Clause 25. The method of clause 23 or clause 24, wherein the blood or blood product sample is applied to the sample inlet of the first layer.

Clause 26. The method of any of clauses 23-25, wherein the plasma comprises less than 5% by volume red blood cells.

Clause 27. The apparatus of any of clauses 1-3, wherein the at least one microchannel extends along a width of a portion of the hydrophobic layer to an opening at a second end. Claims 28. The apparatus of any of claims 1-20, wherein the top layer, hydrophobic layer, bottom layer, hydrophilic mesh or hydrophilic film, separation membrane, or any combination thereof is either ubiquitous for any analyte or specific for an analyte or class of analytes.

What is claimed is:

1. An apparatus for fluid sample processing comprising:
a hydrophobic layer comprising at least one microchannel having a first and second end and which defines a path for capillary fluid flow; and
a top layer flanking the hydrophobic layer, wherein a surface of the top layer facing the hydrophobic layer is hydrophilic,
wherein the sample comprises blood or blood products.

2. The apparatus of claim 1, further comprising a bottom layer flanking the hydrophobic layer, wherein a surface of the bottom layer facing the hydrophobic layer is hydrophilic.

3. The apparatus of claim 1, wherein the top layer, hydrophobic layer, bottom layer, or any combination thereof are adherent to each other.

4. The apparatus of claim 1, wherein the at least one microchannel extends longitudinally along a portion of the hydrophobic layer to an opening at a second end.

5. The apparatus of claim 1, wherein the at least one microchannel is less than about 80 mm in length.

6. The apparatus of claim 1, wherein the at least one microchannel is less than about 5 mm wide.

7. The apparatus of claim 1, wherein the top layer, bottom layer or top and bottom layers are entirely hydrophilic.

8. The apparatus of claim 1, wherein a composition of the entirety of the top layer, bottom layer, or both the top and bottom layers each comprise same or different materials.

9. The apparatus of claim 1, wherein the hydrophobic layer, top layer, bottom layer or any combination thereof have a combined thickness of about 100 to about 600 microns.

10. The apparatus of claim 1, wherein the hydrophobic layer has thickness of about 50 to about 200 microns.

11. The apparatus of claim 1, wherein each of the top layer, bottom layer, or top and bottom layers have a thickness of about 50 to about 200 microns.

12. The apparatus of claim 1, wherein the top layer comprises a sample inlet.

13. The apparatus of claim 12, wherein the hydrophobic layer and optionally, the bottom layer, comprise an opening below the sample inlet.

14. The apparatus of claim 12, wherein the sample inlet comprises a separation membrane.

15. The apparatus of claim 14, wherein the separation membrane is a plasma separation membrane.

16. The apparatus of claim 14, further comprising a hydrophilic mesh or hydrophilic film positioned above the separation membrane, below the separation membrane, or both above and below the separation membrane.

17. The apparatus of claim 13, wherein the opening in the hydrophobic layer is connected to the first end of the at least one microchannel.

18. The apparatus of claim 1, further comprising an agglutinating agent.

19. The apparatus of claim 18, wherein the agglutinating agent comprises lectin, Merquat-100, Concanavalin A, DEAE-Dextran, poly-L-lysine, polyvinylpyrrolidone, poly(2-(dimethylamino)ethylmethacrylate), or any combinations thereof.

20. The apparatus of claim 18, wherein the agglutinating agent is coated or incorporated into the separation membrane, the top layer, the hydrophobic layer, the bottom layer, or any combination thereof.

21. A device comprising:
the apparatus of claim 1; and
a sample analysis cartridge having a sample application area,
wherein the apparatus is configured within the sample analysis cartridge such that the at least one microchannel is in fluid communication with the sample application area.

22. The device of claim 21, wherein an opening at the second end of the at least one microchannel is in fluid communication with the sample application area.

23. A method for separating plasma from a blood or blood product sample, the method comprising:
collecting or receiving the blood or blood product sample;
contacting the blood or blood product sample with the apparatus of claim 1; and
obtaining the plasma from an opening at the second end of the at least one microchannel.

24. The method of claim 23, wherein the blood or blood product sample has a volume of about 10 to about 500 uL.

25. The method of claim 23, wherein the blood or blood product sample is applied to the sample inlet in the first layer.

26. The method of claim 23, wherein the plasma comprises less than 5% by volume red blood cells.
